(19) United States
(12) Patent Application Publication
(10) Pub. No.: US 2025/0292136 A1
(43) Pub. Date: Sep. 18, 2025

(54) SEISMIC INVERSION USING QUANTUM COMPUTING

(71) Applicant: Schlumberger Technology Corporation, Sugar Land, TX (US)

(72) Inventors: Divakar Vashisth, Stanford, CA (US); Rodney William Lessard, Menlo Park, CA (US)

(21) Appl. No.: 18/602,186

(22) Filed: Mar. 12, 2024

(51) Int. Cl. G06N 10/60

(52) U.S. Cl. CPC G06N 10/60

(57) ABSTRACT

A method implements seismic inversion using quantum computing. The method includes encoding a first objective function and trace values as a first Ising model Hamiltonian, annealing the first Ising model Hamiltonian to obtain a first result, and decoding the first result to output reflectivity values. The method further includes encoding a second objective function and the reflectivity values as a second Ising model Hamiltonian, annealing the second Ising model Hamiltonian to obtain a second result, and decoding the second result to output acoustic impedance values.

### BACKGROUND

Seismic inversion is used in the hydrocarbon industry to facilitate the transformation of observed seismic data into a quantitative rock property description, often focusing on attributes such as impedance. The inversion process refines the subsurface image, offering insights into rock properties that are directly related to the presence, type, and saturation level of hydrocarbons. By converting the reflection amplitude data (gathered from seismic surveys and also referred to as trace data) into a model of the subsurface acoustic or elastic properties, geoscientists and reservoir engineers generate images of potential hydrocarbon-bearing formations. The images may be used for reservoir modeling, optimizing well placement, and enhancing production strategies. Seismic inversion may be used in other industries. For example, in the geothermal industry, seismic inversion may be used to identify zones of potential geothermal activity by mapping subsurface temperature gradients and reservoir properties. For Carbon Capture and Storage (CCS) projects, seismic inversion may be used to delineate, monitor, and verify the secure containment of sequestered carbon dioxide (CO₂) for long-term stability and minimization of environmental risks. A challenge is to perform seismic inversion in an expedient manner to generate acoustic impedance data from trace data.

### SUMMARY

In general, in one or more aspects, the disclosure relates to a method that implements seismic inversion using quantum computing. The method includes encoding a first objective function and trace values as a first Ising model Hamiltonian, annealing the first Ising model Hamiltonian to obtain a first result, and decoding the first result to output reflectivity values. The method further includes encoding a second objective function and the reflectivity values as a second Ising model Hamiltonian, annealing the second Ising model Hamiltonian to obtain a second result, and decoding the second result to output acoustic impedance values.

Other aspects of the one or more embodiments may be apparent from the following description and the appended claims.

### BRIEF DESCRIPTION OF DRAWINGS

FIG. 1 shows a diagram in accordance with one or more embodiments of the disclosure.

FIG. 2.1 and FIG. 2.2 show methods in accordance with one or more embodiments of the disclosure.

FIG. 3 and FIG. 4 show examples in accordance with one or more embodiments of the disclosure.

FIG. 5.1 and FIG. 5.2 show computing systems in accordance with one or more embodiments.

Similar elements in the various figures are denoted by similar names and reference numerals. The features and elements described in one figure may extend to similarly named features and elements in different figures.

### DETAILED DESCRIPTION

Embodiments of the disclosure perform seismic trace inversion. The seismic inversion is a practical application of classical and quantum processing. Embodiments may be implemented on a quantum computer using annealing or implemented using a classical stochastic global optimizer that simulates quantum annealing or other natural phenomena such as thermal annealing. Quantum annealing (referred to simply as “annealing”) is a computational technique for finding the minimum energy state of a given objective function using a quantum computer. The approach for seismic inversion may involve a two-step workflow. First, reflectivities are estimated from seismic trace data. After estimating the reflectivities, acoustic impedances are predicted based on the determined normal-incidence reflectivities generated from the first step. A hybrid quantum-classical solver may be employed to deduce the acoustic impedances from the seismic data. A single iteration of the workflow implemented with a quantum system may generate impedances that matched closely with true values. In contrast, simulated annealing may utilize multiple (e.g., 10) iterations to reach a similar accuracy. Furthermore, the quantum processing unit (QPU) within the hybrid solver may take a minimal amount of time (e.g., within 10% of 0.08 seconds) to estimate seismic impedances. This time frame is notably efficient when compared to the time used by both the classical component of the hybrid solver and simulated annealing, which may each take over 10 seconds. Due to the restricted number of fully-connected qubits in the QPUs presently available, the seismic inverse problem may not be directly addressed on the QPUs. Consequently, a hybrid solver may be utilized, combining quantum and classical methods.

The workflow to perform seismic inversion may utilize two annealing steps, which may be performed by a quantum system or a simulated quantum system. For the first annealing step, trace data and a first objective function are encoded into a first Ising model Hamiltonian. The first Ising model Hamiltonian is annealed to minimize the first objective function and generate a first result. The first result is decoded to generate reflectivity data that corresponds to the trace data. For the second annealing step, the reflectivity data may be combined with low frequency acoustic impedance data in a second objective function that is encoded to a second Ising model Hamiltonian. The second Ising model Hamiltonian is annealed to generate a second result. The second result is decoded to generate acoustic impedance data corresponding to the reflectivity data and the trace data.

After generating the acoustic impedance data, the user may explore the data. For example, the trace data, the reflectivity data, and the acoustic impedance data may be displayed on a user device in one or more graphs. Values for the trace data, the reflectivity data, and the acoustic impedance data may be generated and displayed in response to user inputs, which may include the user hovering a mouse over one of the graphs to display the coordinates of a curve in the graphs.

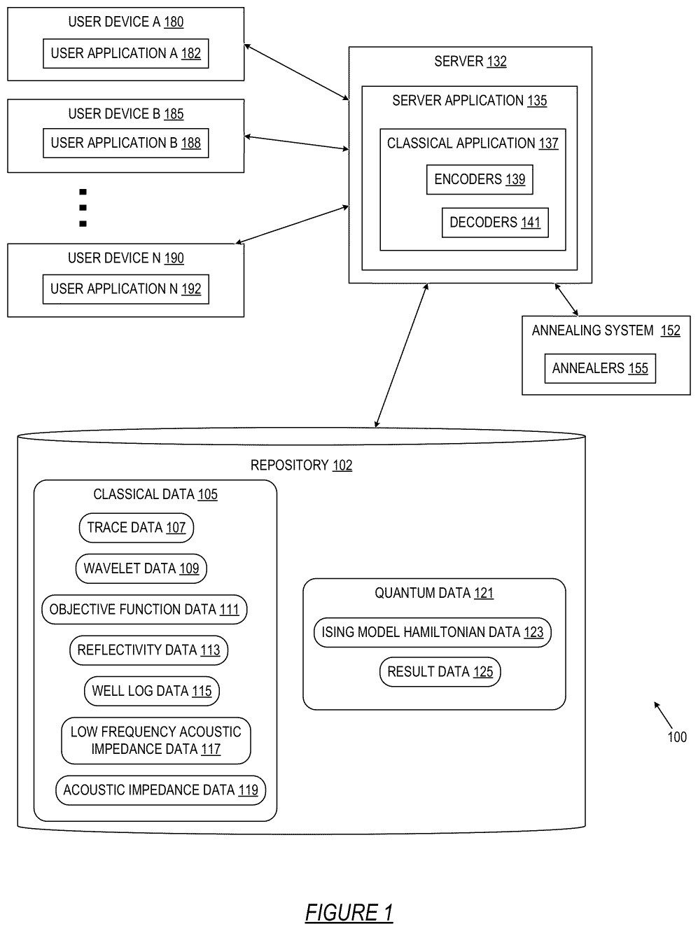

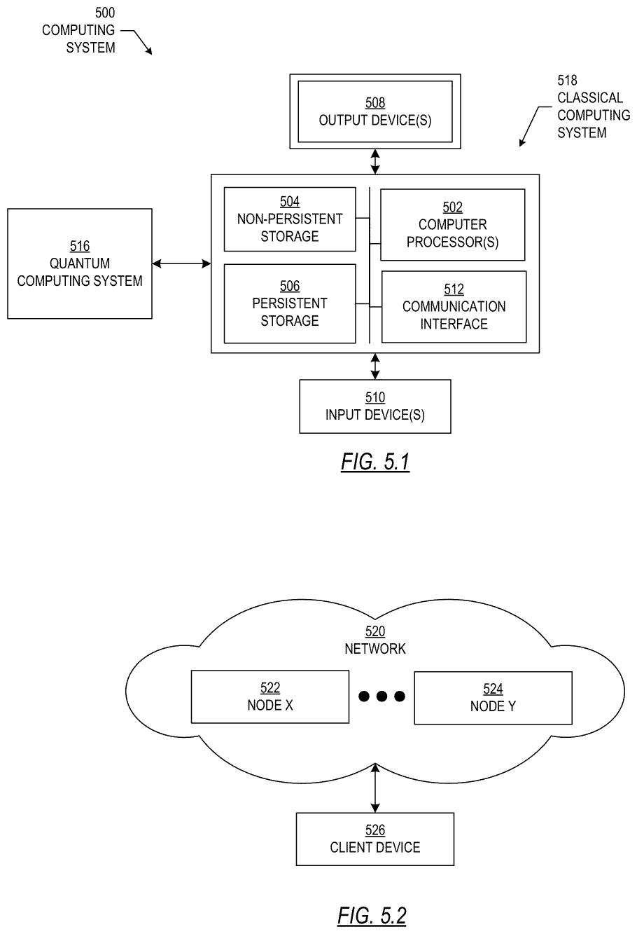

Turning to FIG. 1, the system (100) is a computing system shown in accordance with one or more embodiments. The system (100) and corresponding components may utilize the computing systems described in FIG. 5.1 and FIG. 5.2 to implement seismic inversion using quantum computing. The system (100) may use quantum computing systems and methods with classical computing systems and methods to form a hybrid computing system that uses both classical and quantum methods. The quantum methods may include annealing algorithms performed by the annealing system (152), which may operate as a quantum system to perform quantum calculations using qubits or as a simulated quantum system to perform simulated quantum calculations using classical (binary) bits. The system (100) includes the repository (102), the server (132), the quantum computing system (153), and the user devices A (180) and B (185) through N (190).

The repository (102) is a type of storage unit and/or device (e.g., a file system, database, data structure, or any other storage mechanism) for storing data. The repository (102) may include multiple different, potentially heterogeneous, storage units and/or devices. The repository (102) stores data utilized by other components of the system (100). The data stored by the repository (102) includes the classical data (103) and the quantum data (115).

The classical data (103) is data that may be represented by sets of classical bits. The classical bits may have binary values of zero (“0”) or one (“1”). The classical data (103) includes the trace data (107), the wavelet data (109), the objective function data (111), the reflectivity data (113), the well log data (115), the low frequency acoustic impedance data (117), and the acoustic impedance data (119).

The trace data (107) is data of a seismic trace, which may be stored as a sequence of values that identify the time and amplitude of seismic signals at a particular location. Seismic trace data is a type of geophysical data that is used in the field of exploration geophysics to image and analyze the subsurface structure of the Earth's crust. A seismic trace that may form part of the trace data (107) may be a record of the amplitude of seismic waves that have been reflected or refracted from subsurface rock formations, as a function of time. Seismic trace data may be acquired using a technique called reflection seismology, which may involve generating seismic waves at a location on the surface of the Earth using a vibration source, such as a vibrator truck or an air gun, and then recording the waves that are reflected back to the surface by subsurface rock formations using a series of geophones or hydrophones.

The wavelet data (109) is data that represents “source” wavelets used by the system. The wavelet data (109) may be stored as a sequence of values that describe the waveform of a wavelet, (e.g., the Ricker wavelet). Wavelets may be used as part of wavelet transforms, which are mathematical tools used to analyze data in both time and frequency domains. The wavelet data (109) is used as a representation of an acoustic impulse function.

The objective function data (111) is data that represents objective functions. An objective function, which may also be referred to as an optimization function, is a mathematical function that is used to optimize a certain outcome or goal in a given problem or system. The term “objective function” is used as the function represents the objective or target that the problem is trying to achieve. In optimization problems, the objective function takes in a set of decision variables as input and returns a single scalar value as output, which represents the objective or goal that is being optimized. The decision variables are the controllable inputs that can be adjusted to optimize the objective function. The objective function may be either a maximization function or a minimization function, depending on the problem at hand. In a maximization problem, the goal is to find the set of decision variables that maximize the value of the objective function. In a minimization problem, the goal is to find the set of decision variables that minimize the value of the objective function.

The reflectivity data (113) is data that represents reflectivities. Reflectivities include reflection coefficients that describe the general tendency of a material to reflect sound based on its acoustic impedance. High reflectivity indicates that a large portion of the sound energy will be reflected, while low reflectivity means most of the sound will be transmitted through the material. Reflectivity may be a relative property used to compare the behavior of a material to other materials or a reference medium. Quantitatively, reflectivities and reflection coefficients may measure sound reflection. Reflection coefficients may be calculated as the ratio of the amplitude of the reflected wave to the amplitude of the incident wave, both expressed as complex numbers (phasors). Values range from −1 to 1. A value of −1 indicates perfect reflection where the incident energy is fully reflected and none is transmitted. A value of 0 indicates perfect transmission where the incident energy is fully transmitted through the medium and none is reflected. Values between −1 and 0 indicate partial reflection and partial transmission, where some energy is reflected and some is transmitted. The values of reflection coefficients are based on the acoustic impedances of the two materials involved and the angle of incidence of the sound wave transmitted through the materials.

The well log data (115) is data collected into well logs. Well logs include information collected from drilling operations in the oil and gas industry. Well logs are detailed records that provide information about the geological formations penetrated by a well or borehole. The data is collected using specialized tools, also known as logging tools, which are lowered into the well on a wireline and may include a variety of measurements. Density measurements provide information about the density of the rock formations, which can help identify the type of rock and corresponding porosity. Sonic measurements provide information about the velocity of sound through the rock formations, which may help identify the type of rock and its porosity. Resistivity measurements provide information about the electrical conductivity of the rock formations, which can help identify the presence of hydrocarbons. Gamma ray measurements provide information about the natural radioactivity of the rock formations, which can help identify the type of rock and its composition. Porosity measurements provide information about the amount of pore space in the rock formations, which can help identify the potential for hydrocarbon storage. The well log data may be used to generate the low frequency acoustic impedance data (117).

The low frequency acoustic impedance data (117) is data that describes the low frequency acoustic impedance of a site. Acoustic impedance (AI) data is a measurement used in the field of geophysics to characterize the physical properties of geological materials. Acoustic impedance is a measure of how much a material resists the transmission of sound waves and is calculated by multiplying the density of the material by the velocity of sound waves traveling through the material. Low frequency acoustic impedance may refer to the range of frequencies below a low frequency threshold value, for example, 10 Hertz (Hz). The low range of frequencies may be useful for subsurface exploration, to provide information about the structural and lithological properties of geological formations.

The acoustic impedance data (119) is data that quantifies acoustic impedance. Acoustic impedance is a measure of how much a material resists the transmission of sound waves. The acoustic impedance data (119) may include low and high frequency acoustic impedance data with frequencies above and below the low frequency threshold value.

The quantum data (115) is information that is encoded and may be processed using quantum-mechanical systems and methods, including quantum bits or “qubits”. In contrast to the classical data (105), which is represented in bits that can have a value of either “0” or “1”, qubits may exist in a superposition of states, meaning a qubit may be in multiple states at once. The quantum data (115) may be encoded into the probability of the states represented by qubits. Superposition, along with other properties, such as entanglement and quantum interference, allows quantum data to be processed and manipulated in ways that are not possible with classical data. The quantum data (115) includes the Ising model Hamiltonian data (123) and the result data (125).

The Ising model Hamiltonian data (123) is information that represents an encoded form of the objective function data (111) that is suitable for processing with quantum systems and methods. An Ising model Hamiltonian is a Hamiltonian for an Ising model. The Ising model is a mathematical model used in statistical physics and computer science to describe a system of spins, which can take on one of two values, which may be denoted by ±1 or ↑↓. The spins are arranged on a lattice, and each spin interacts with its neighboring spins through a Hamiltonian, which is an energy function describing the interactions between the spins. The Hamiltonian of an Ising model (i.e., the Ising model Hamiltonian) may be loaded to a quantum system and evolved to generate the results stored as the result data (125).

The Hamiltonian for the Ising model may be written as:

$$H = - {\sum }_{〈 i j 〉} J {σ}_{i} {σ}_{j} - {\sum }_{j} h {σ}_{j} \qquad ( 1 )$$

where J represents spin-spin interaction, h represents the external field, and σᵢ and σⱼ are the individual spin lattice sites i and j. The first sum is over each of the pairs of neighboring lattice sites (a.k.a. bonds); it represents the interactions between spins. The second sum is over each of the lattice sites themselves, representing the external field trying to align the spins in one direction.

The result data (125) is information that describes the results of annealing the Ising model Hamiltonians of the Ising model Hamiltonian data (123). Annealing the Ising model Hamiltonian data (123) optimizes the objective functions of the objective function data (111) to form the result data (125).

Continuing with FIG. 1, the system (100) also may include the server (132). The server (132) is one or more classical computing systems, possibly in a distributed computing environment. A classical computing system performs calculations using “bits” where a bit may have a value of “1” or “0”. An example of the server (132) may be the computing system (500) shown in FIG. 5.1.

The server (132) may host and/or execute one or more processes, software, applications, etc. For example, the server (132) may execute one or multiple instantiations of the server application (135) using different computing systems and servers. The server (132) may interact with the quantum computing system (153) and the user devices A (180) and B (185) through N (190).

The server application (135) is a collection of programs operating on the server (132). The server application (135) may act as in interface between the user devices A (180) and B (185) through N (190) and the classical application (137) to process the trace data (107) and generate the acoustic impedance data (119) using the annealing system (152).

The classical application (137) is a collection of programs operating on the server (132). The classical application (137) processes the classical data (105) and interfaces with the annealing system (152) to process the quantum data (121) using the encoders (139) and the decoders (141).

The encoders (139) encode information for processing on the annealing system (152). The encoders (139) map the logical qubits from the logical space of classical bits to the physical space of qubits. The encoders translate the logical quantum state into a physical quantum state that can be processed by the annealing system (152). The encoding process may involve error correction. Quantum systems may be prone to errors due to environmental noise and imperfections. As an example, drift correction may be applied to the annealing system (152) to reduce the flux noise of the qubits of the annealing system (152). The encoders (139) operate by transforming the logical qubits into a physical quantum state that can be processed by the annealing system (152).

In an embodiment, the encoders (139) include a first encoder that encodes the trace data (107), the wavelet data (109), and the objective function data (111) for a first objective function into a first Ising model Hamiltonian of the Ising model Hamiltonian data (123) to be processed by the annealing system (152). The encoders (139) may include a second encoder that encodes the reflectivity data (113), the low frequency data acoustic impedance data (117), and the objective function data (111) for a second objective function into a second Ising model Hamiltonian of the Ising model Hamiltonian data (123) to be processed by the annealing system (152).

The decoders (141) decode information generated by the annealing system (152). The decoders (141) may also provide error correction to detect and correct errors that occur during quantum computations due to the fragile nature of qubits. Qubits may exist in a superposition of both 0 and 1 simultaneously and are susceptible to errors from environmental noise and imperfect quantum operations. The decoders (141) may provide error correction and measure the physical quantum states from the qubits of the annealer system (152) to be stored as binary data in the classical data (105).

In an embodiment, the decoders (141) include a first decoder that decodes the reflectivity data (113) from the result data (125) generated in response to annealing a first Ising model Hamiltonian. The decoders (141) may include a second decoder that decodes the acoustic impedance data (119) from the result data (125) generated in response to annealing a second Ising model Hamiltonian. The annealing system (152) applies quantum mechanical properties of matter (or simulations thereof) to perform calculations. Calculations performed with quantum computing systems using qubits may be performed much more efficiently than with classical computing systems that use classical binary bits for computations.

The annealing system (152) performs calculations using “qubits” where a qubit may exist as a superposition of both states “1” and “0” simultaneously. The annealing system (152) may execute the annealers (155).

The annealers (152) are components of the annealing system (152). The annealers (152) operate as quantum computing systems to solve optimization problems. The optimization problems are solved using quantum annealing to find the lowest energy state of a system, which corresponds to the optimal solution for the problem. Quantum annealing is a type of quantum computation that exploits the quantum mechanical phenomena of superposition and tunneling to explore the solution space of a problem. To generate a result, one of the annealers (155) starts in a superposition of the possible solutions, and then gradually transitions to a single solution as the system is annealed, or cooled down. The annealing process allows the annealer to explore a much larger solution space than would be possible with classical computation, and may find an optimal solution more quickly. The annealer uses quantum bits (qubits) to encode the problem's variables and possible values. The qubits are initialized in a superposition of their basis states, and the system is then allowed to evolve according to a Hamiltonian from the Ising model Hamiltonian data (123). The Hamiltonian provides a mathematical description of the energy levels of the quantum system and the transitions between the energy levels. By carefully controlling the Hamiltonian, an annealer guides the system towards the ground state, which corresponds to an optimal solution.

Continuing with FIG. 1, the user devices A (180) and B (185) through N (190) may interact with the server (132). The user devices A (180) and B (185) through N (190) may be computing systems in accordance with FIG. 5.1 and FIG. 5.2. The user devices A (180) and B (185) through N (190) may include and execute the user applications A (182) and B (188) through N (192).

The user applications A (182) and B (188) through N (192) are programs that operate on the user devices A (180) and B (185) through N (190) to provide user interaction by collecting user inputs and displaying outputs in response to the user inputs. The user applications A (182) and B (188) through N (192) may include user interfaces with user interface elements to receive inputs and display outputs to users of the system (100).

In one or more embodiments, the user device A (180) is operated by a user to update the classical data (105), generate the quantum data (121), and display outputs. For example, in response to a user identifying the trace data (107), the wavelet data (109) and the well log data (115), which the system (100) then processes to generate the result data (125), the reflectivity data (113), the low frequency acoustic impedance data (117), and the acoustic impedance data (119). The system (100) may then present portions of the classical data (105) to the user devices A (180) and B (185) through N (190) that are displayed with the user applications A (182) and B (188) through N (192).

Although described within the context of a client server environment with servers and user devices, aspects of the disclosure may be practiced with a single computing system and application. For example, a monolithic application may operate on a computing system to perform the same functions as one or more of the applications executed by the server (132) and the user devices A (180) and B (185) through N (190).

FIG. 5.1 and FIG. 5.2 illustrate the processes (200) and (250) for seismic inversion using quantum computing. In one embodiment, a system may include at least one processor and an application that, when executing on the at least one processor, performs one or more of the processes (200) and (250). In one embodiment, a non-transitory computer readable medium may include instructions that, when executed by one or more processors, perform the processes (200) and (250).

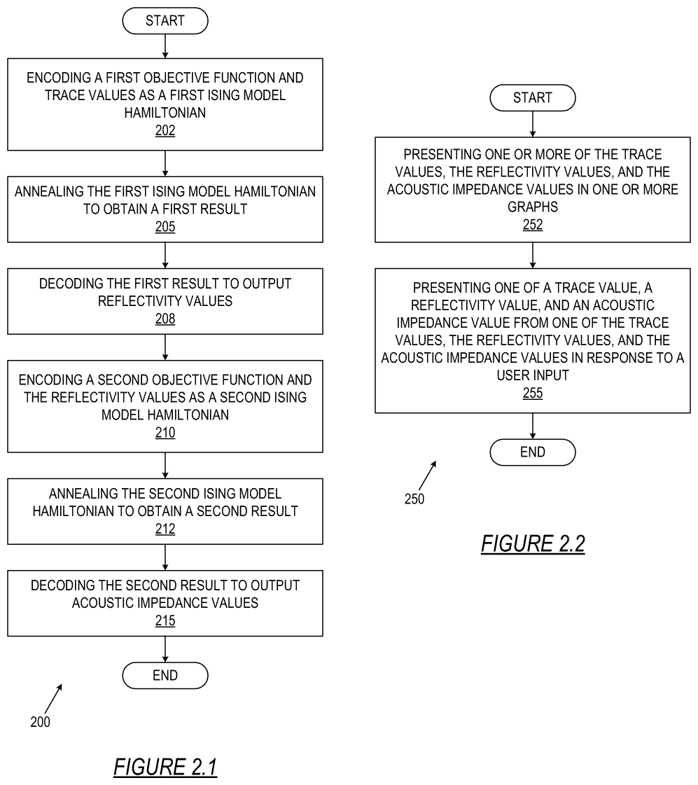

Turning to FIG. 2.1, the process (200) implements seismic inversion using quantum computing. The process (200) includes multiple steps that may execute on the components described in the other figures, including those of FIG. 1 and FIG. 5.1.

Block 502 includes encoding a first objective function and trace values as a first Ising model Hamiltonian. The encoding encodes the first objective function into a Quadratic Unconstrained Binary Optimization (QUBO) or Ising model Hamiltonian as a part of adiabatic quantum computing and quantum annealing. The encoding maps the objective function to a form that can be solved by a quantum computer. The Ising model is a mathematical framework used to describe the behavior of magnetic systems that may be used to represent a wide range of optimization problems. The Ising model describes a system of spins, which can take on values of +1 or −1, that interact with each other. An Ising model Hamiltonian may be given by Equation (1) above, which may be reformulated to the first objective function given by Equation (2) below.

$${E}_{1} = {\sum }_{t} [ {( {d}_{seis} ( t ) - r ( t ) * w ( t ) )}^{2} ] \qquad ( 2 )$$

where dₛₑᵢₛ(t) is the seismic trace data, r(t) is the reflectivity series, w(t) represents the source wavelet, which, in this context, is the Ricker wavelet, and E₁ represents the error of the objective function, and is the energy of the system during annealing. The first objective function utilizes the fact that the trace values are equal to the reflectivity values convolved with the wavelet values as shown in Equation (3).

$${d}_{seis} ( t ) = r ( t ) * w ( t ) \qquad ( 3 )$$

Encoding the first objective function into the first Ising model Hamiltonian involves mapping the variables of the objective function from a real value domain to the quantum domain of the spins of the Ising model. In the first objective function, dₛₑᵢₛ(t) and w(t) represent trace values and wavelet values, which are known, and r(t) represents the reflectivity values, which are unknown. The real values and unknown variables are transformed into information stored in qubits, which is in a form that may be solved using quantum annealing by the encoding process.

Block 505 includes annealing the first Ising model Hamiltonian to obtain a first result. The annealing may be performed on a quantum computing system or a simulated quantum computing system. During the annealing process, the reflectivity values are represented with a number of quantum bits. For example, a reflectivity value may be represented with 20 spin variables. The process of annealing finds the ground state (i.e., the state with the lowest energy) of the first Ising model Hamiltonian for the first objective function. To anneal the first Ising model Hamiltonian, the first Ising model Hamiltonian is defined, which was performed during the encoding at Block 502.

With simulated annealing using classical computation with binary bits, the system is may be initialized to assign random values to simulated qubits (e.g., random spins) representing variables with unknown values. The temperature of the system is set to a relatively high temperature for the system to be in a disordered state with the spins randomly oriented. As the temperature is lowered, the system reaches a low temperature, ordered state that contains the first result from which the reflectivity values may be obtained.

Quantum annealing may analogize to aspects of simulated annealing with classical computing but may provide additional features useful for computation. With quantum annealing, the qubits, instead of being initialized with random values, are initialized in a superposition of each of the possible states, allowing the system to explore many possible configurations simultaneously. Another feature of quantum annealing is the use of quantum tunneling to allows the system to escape local minima and explore the solution space more efficiently than classical thermal fluctuations (as in simulated annealing). With quantum annealing, the annealing schedule gradually reduces the strength of the transverse field, which is responsible for maintaining the superposition of states. The reduction may be analogous to lowering the temperature in classical annealing but involves tuning quantum parameters rather than thermal temperature. At the end of the quantum annealing process, the qubits are measured, collapsing the superposition of states of the qubits to a specific state that represents the solution to the optimization problem.

Quantum annealers may also be referred to as adiabatic annealers that evolve quantum systems. The quantum annealer starts the system with a Hamiltonian in a known ground state (lowest energy) and slowly evolves the system to the problem Hamiltonian. When the evolution is slow enough, the system will evolve to the ground state of the problem Hamiltonian.

In an embodiment, the first objective function combines the trace values with the reflectivity values and the reflectivity values are convolved with wavelet values. As shown in Equation (2), the convolution of the reflectivity values with the wavelet values is subtracted from the trace values. The result from the subtraction is squared and summed for the values of t to identify the error of the reflectivity values.

Block 508 includes decoding the first result to output reflectivity values. Decoding is the process of interpreting the solution obtained from the quantum computer. Decoding involves retrieving the solution, measuring the final state of the qubits of the quantum computing system, to convert information stored in qubits into logical binary bits. The result from the quantum computing system after annealing the first Ising model Hamiltonian is converted into the reflectivity values. The reflectivity values are represented with classical bits that may be stored in a repository.

The second objective function may be given by Equation (4) below.

$${E}_{2} = {\sum }_{t} [ {( {A}_{i + 1} ( t ) \cdot ( 1 - r ( t ) ) - {A}_{i} ( t ) \cdot ( 1 + r ( t ) ) )}^{2} + {λ ( {A}_{i} ( t ) - {A}_{LF} ( t ) )}^{2} ] \qquad ( 4 )$$

where Aᵢ(t) is the acoustic impedance at the current time step/sample, and Aᵢ₊₁(t) is acoustic impedance at the next/following time sample, r(t) is the reflectivity series (generating from the first annealing step), λ is a regularization parameter, A_{LF}(t) is an acoustic impedance of a low frequency trend or model at the current time sample, and E₂ represents the error of the objective function and is the energy of the system during annealing.

Equation (4) includes a high frequency portion:

$${( {A}_{i + 1} ( t ) \cdot ( 1 - r ( t ) ) - {A}_{i} ( t ) \cdot ( 1 + r ( t ) ) )}^{2} \qquad ( 5 )$$

and a low frequency portion:

$${λ ( {A}_{i} ( t ) - {A}_{L F} ( t ) )}^{2} \qquad ( 6 )$$

In an embodiment, the distinction between high frequency and low frequency may be in the range of 1.5 to 250 Hz.

The regularization parameter (λ) determines whether low frequencies or high frequencies dominate the result. Lower values of the regularization parameter (λ) (e.g., closer to 0) allow the high frequencies to dominate by minimizing the low frequency portion (6) and higher values of the regularization parameter (λ) (e.g., closer to 1) allow the low frequencies to dominate by not minimizing the low frequency portion (5).

An issue with seismic data is that seismic data may lack low frequency content. The lack of low frequency content may be due to seismic surveys being designed to capture higher-frequency data, as high frequencies carry detailed information about the subsurface structures. The absence of low frequency data may limit the ability to tie the seismic data to physical rock properties, such as impedance. Higher frequency seismic data may provide changes in rock properties, but without lower frequency data, a baseline or an absolute value to start from may not be available. A low frequency model may be added in seismic inversion to compensate for the lack of low frequency information in the seismic data. The low frequency model provides the low frequency background trend or base model upon which the higher-frequency details are superimposed.

The low frequency model may be created using well log data and is referred to as the background model. Incorporating the low frequency model into seismic inversion may include several steps.

Well log data is gathered. Well log data provides direct measurements of rock properties at various depths. Common logs used for building the low frequency model include sonic logs, density logs, and resistivity logs that are gathered with equipment at a well.

Acoustic impedance is calculated. The acoustic impedance (for low frequencies) is calculated from the well log data at each depth level.

Low frequency trend is extracted. The high frequency noise is filtered out from the impedance log to obtain the low frequency trend or background model. The filtering may be achieved through a variety of methods, including using a moving average, polynomial fitting, or other types of low-pass filters.

Spatial Extrapolation is performed. The low frequency model, which may be for a single well location or multiple wells, is extrapolated to a seismic survey area. Extrapolation may use geostatistical methods, including kriging or co-kriging, taking into account the geological continuity, variations observed in the well data, and other available geologic or geophysical data.

The low frequency model is incorporated into the inversion process. The low frequency model is then incorporated into the inversion process, providing the low frequency trend of the subsurface property model. The seismic inversion process may incorporate the low frequency model directly into the objective function (as with Equation (4)). Direct incorporation may add a regularization term to the objective function that penalizes differences between the model obtained from the inversion and the low frequency model.

Low-frequency trend extraction from the acoustic impedance calculated from well log data includes filtering out high-frequency components to reveal the broader, low frequency trend. Filtering may be achieved using various signal processing methods such as moving averages, polynomial fitting, or other types of low-pass filters. The low frequency model helps in stabilizing the inversion process and constraining the solution to physically meaningful results. Without a low frequency model, seismic inversion may yield non-unique or non-realistic results. Integrating a low frequency model derived from well logs or other independent sources into the seismic inversion process leads to accurate subsurface characterization.

The low frequency model may be incorporated directly into the objective function of Equation (4). The incorporation is done by including the regularization parameter (λ) to the low frequency portion (6) to penalize differences between the model (acoustic impedances) obtained from the inversion and the low frequency model.

Block 512 includes annealing the second Ising model Hamiltonian to obtain a second result. In an embodiment, the second Ising model Hamiltonian represents the second objective function of Equation (4) using quantum bits. The quantum bits may include 20 spin variables for each unknown acoustic impedance value being annealed.

Block 515 includes decoding the second result to output acoustic impedance values. Decoding the second result converts values of the result of the second annealing stored in quantum bits to the acoustic impedance values stored as classical bits.

Turning to FIG. 2.2, the process (250) uses seismic inversion with quantum computing to display information. The process (250) includes multiple steps that may execute on the components described in the other figures, including those of FIG. 1 and FIG. 5.1.

Block 552 includes presenting one or more of the trace values, the reflectivity values, and the acoustic impedance values in one or more graphs. The reflectivity values may be automatically generated in response to receiving the trace values, and the acoustic impedance values are automatically generated in response to receiving the reflectivity values. The values may be presented by transmitting the values from a server to a user device which displays the values plotted in the graphs. The graphs may be displayed in a user interface operated by a user application executing on the user device and communicating with the server.

Block 555 includes presenting one of a trace value, a reflectivity value, and an acoustic impedance value from one of the trace values, the reflectivity values, and the acoustic impedance values in response to a user input. In an embodiment, the user input may include hovering a mouse over a graph of the one or more graphs. For example, a user may display the graphs and then move a mouse cursor to a curve in one of the graphs. Upon hovering over the curve, the system may display the coordinates that correspond to the location of the mouse on the curve.

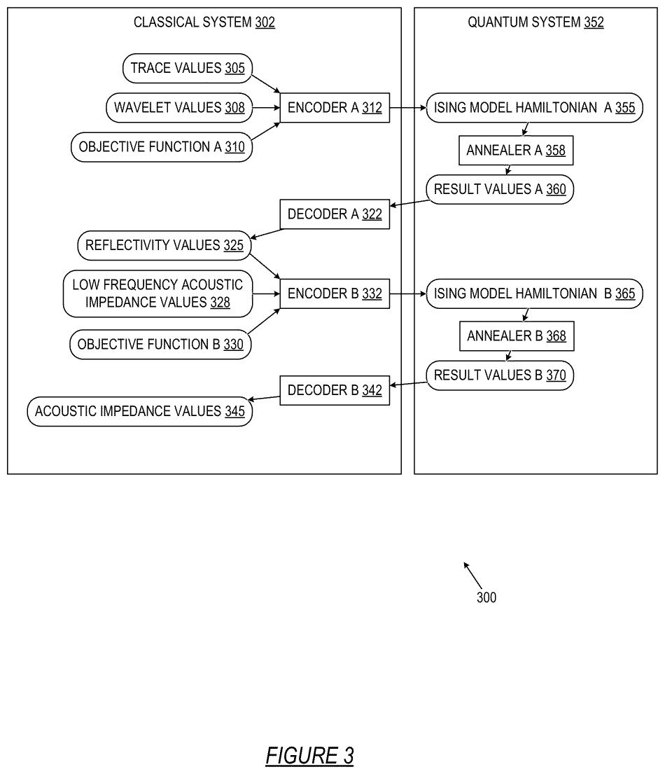

Turning to FIG. 3, the system (300) is a hybrid system that performs seismic inversion using the classical system (302) and the quantum system (352). The classical system (302) stores and processes information using classical bits. The quantum system (352) stores and processes information using quantum bits. The classical system (302) receives the trace values (305), the wavelet values (308), and the objective function A (310).

The encoder A (312) transforms classical information to quantum information by encoding the trace values (305) and the wavelet values (308) using the objective function A (310) to generate the Ising model Hamiltonian A (355) on the quantum system (352). The encoder A (312) transforms the classical information from the classical system (302) to quantum information on the quantum system (352). The objective function A (310) identifies the relationships between the trace values (305), the wavelet values (308), and the reflectivity values (325). Prior to the first annealing step, the trace values (305) and the wavelet values (308) are known and the reflectivity values (325) are unknown.

The annealer A (358) processes the Ising model Hamiltonian A (355) to generate the result values A (360). The annealer A (358) processes the Ising model Hamiltonian A (355) by annealing the qubits of the Ising model Hamiltonian A (355) to reach a low energy ordered state for the result values A (360) that optimize (e.g., minimize) the output of the objective function A (310).

The decoder A (322) transforms quantum information to classical information by processing the result values A (360) to generate the reflectivity values (325). The decoder A (322) measures the quantum information stored in qubits for the result values A (360) on the quantum system (352) to generate the reflectivity values A (325) stored in classical bits on the classical system (302).

The encoder B (332) transforms classical information to quantum information by encoding the reflectivity values (325) and the low frequency acoustic impedance values (328) using the objective function B (330) to generate the Ising model Hamiltonian B (365) on the quantum system (352). The Ising model Hamiltonian B (365) is stored using qubits of the quantum system (352). Prior to the second annealing step, the reflectivity values (325) and the low frequency acoustic impedance values (328) are known and the acoustic impedance values (345) are unknown.

The annealer B (368) processes the Ising model Hamiltonian B (365) to generate the result values B (370). The result values B (370) are generated annealing the Ising model Hamiltonian B (365) to evolve a low energy ordered state for the qubits that store the information of the result values B (370) to optimize (e.g., minimize) the output of the objective function B (330).

The decoder B (342) transforms quantum information to classical information by processing the result values B (370) to generate the acoustic impedance values (345). The decoder B (342) measures the quantum information stored in the qubits for the result values B (370) to generate the acoustic impedance values (345) stored as classical bits on the classical system (302).

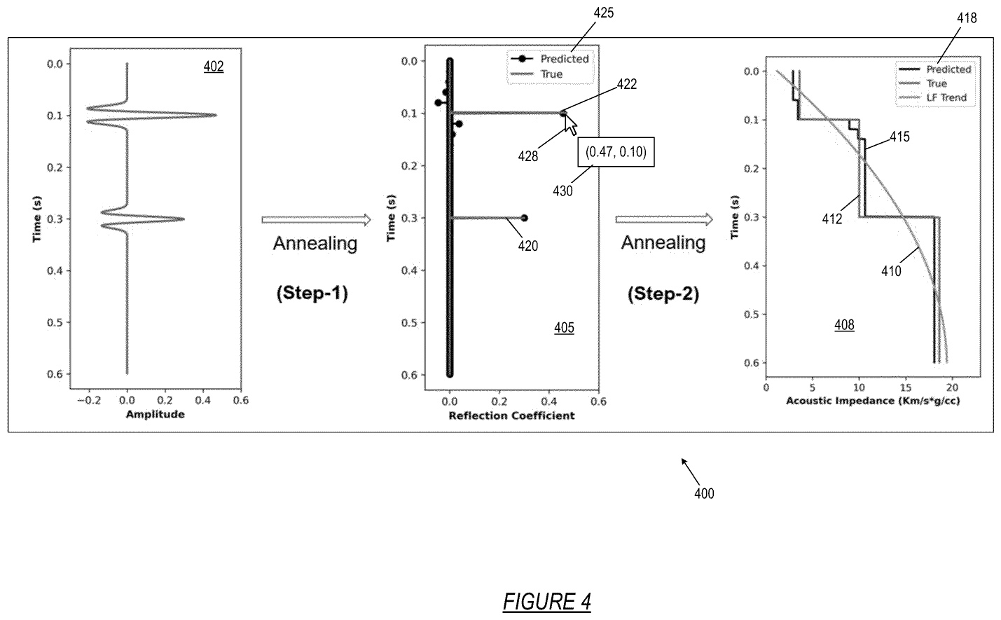

Turning to FIG. 4, the user interface (400) is displayed on a user device in response to inputs from user. The graph (402) displays trace data. The trace data from the graph (402) is annealed with a first objective function to generate the reflectivity data displayed in the graph (405). The reflectivity data displayed in the graph (405) is annealed with a second objective function to generate the acoustic impedance data displayed in the graph (408).

The graph (405) includes plots of reflectivity data with predicted values and true values of the reflectivity data. The predicted values may be generated by annealing the trace data shown in the graph (402). The true values may be obtained using a forward model to process seismic data. The curve (420) may display the true reflectivity values and the curve (422) may display the predicted reflectivity values in a different color and with circles within the curve (422) as identified in the legend (425).

The graph (408) includes plots of acoustic impedance data with predicted values, true values, and low frequency trend values. The predicted values may be generated by annealing the reflectivity data shown in the graph (405). The true values may be obtained using a forward model to process seismic data. The low frequency values may be obtained using geostatistical algorithms applied to seismic data. The low frequency trend values may correspond to the curve (410) that is smooth and rounded. The true values may correspond to the curve (412), which has fewer transitions than the curve (415). The predicted values may correspond to the curved (415), which has more transitions than the curve (412). The curves (410), (412), and (415) may be shown with different colors identified by the legend (418).

The location of the cursor (428) is updated responsive to user input and displays coordinates when the location touches a curve of a graph. For example, the cursor (428) is hovering over the curve (422) and displays the window (430) that identifies the X and Y coordinate values of the curve (422) at the location of the cursor (428).

Embodiments may be implemented on a special purpose computing system specifically designed to achieve the improved technological result. Turning to FIG. 5.1 and FIG. 5.2, the special purpose computing system (500) includes a classical computing system (518) connected to a quantum computing system (516). The quantum computing system (516) includes a quantum computer that is a machine that uses the properties of quantum physics to store data and perform computations with one or more quantum processing units (QPUs). In the quantum computer, the basic unit of memory is a quantum bit or qubit. Qubits are made using physical systems, such as the spin of an electron or the orientation of a photon. Qubits may also be inextricably linked together using a phenomenon called quantum entanglement. The result is that a series of qubits may represent different things simultaneously.

The basic unit of memory for the classical computing system is a bit, whereby each bit has a value of one or zero, but not both one and zero, at a single point in time. As shown in FIG. 8.1, the classical computing system (500) may include one or more computer processors (502), non-persistent storage (504), persistent storage (506), a communication interface (512) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing unit (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (508). The inputs may include text input, audio input, video input, etc., which may be processed and transmitted by the computing system (500) in accordance with the disclosure. The communication interface (512) may include an integrated circuit for connecting the computing system (500) to a network (not shown) (e.g., a local area network (LAN), a wide area network (WAN) such as the Internet, mobile network, or any other type of network), and/or to another device, such as another computing device.

Further, the output devices (508) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (508) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5.1 may be connected to or be a part of a network. For example, as shown in FIG. 5.2, the network (520) may include multiple nodes (e.g., node X (522), node Y (524)). Each node may correspond to a computing system, such as the computing system shown in FIG. 5.1, or a group of nodes combined may correspond to the computing system shown in FIG. 5.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5.1. Further, the client device (526) may include and/or perform all or a portion of one or more embodiments of the disclosure.

The computing system of FIG. 5.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
encoding a first objective function and trace values as a first Ising model Hamiltonian;
annealing the first Ising model Hamiltonian to obtain a first result;
decoding the first result to output reflectivity values;
encoding a second objective function and the reflectivity values as a second Ising model Hamiltonian;
annealing the second Ising model Hamiltonian to obtain a second result; and
decoding the second result to output acoustic impedance values.

2. The method of claim 1, further comprising:
presenting one or more of the trace values, the reflectivity values, and the acoustic impedance values in one or more graphs, wherein the reflectivity values are automatically generated in response to receiving the trace values, and the acoustic impedance values are automatically generated in response to receiving the reflectivity values; and
presenting one of a trace value, a reflectivity value, and an acoustic impedance value from one of the trace values, the reflectivity values, and the acoustic impedance values in response to a user input, wherein the user input comprises hovering a mouse over a graph of the one or more graphs.

3. The method of claim 1, further comprising:
encoding the first objective function, wherein the first objective function combines the trace values with the reflectivity values and the reflectivity values are convolved with wavelet values.

4. The method of claim 1, further comprising:
annealing the first Ising model Hamiltonian to minimize an output of the first objective function, wherein the first result comprises the reflectivity values represented with quantum bits during the annealing.

5. The method of claim 1, further comprising:
decoding the first result to output the reflectivity values, wherein the reflectivity values are represented with classical bits after the decoding.

6. The method of claim 1, further comprising:
generating low frequency acoustic impedance values, used in the second objective function, from well log data.
encoding the second objective function, wherein the second objective function combines the acoustic impedance values with the reflectivity values and combines the acoustic impedance values with low frequency acoustic impedance values and a regularization parameter.

7. The method of claim 1, further comprising:
annealing the second Ising model Hamiltonian to minimize an output of the second objective function, wherein the second result comprises the acoustic impedance values represented with quantum bits during the annealing.

8. The method of claim 1, further comprising:
decoding the second result to output the acoustic impedance values, wherein the acoustic impedance values are represented with classical bits after the decoding.

9. The method of claim 1, further comprising:
annealing one or more of the first Ising model Hamiltonian and the second Ising model Hamiltonian by quantum annealing using a quantum system.

10. The method of claim 1, further comprising:
annealing one or more of the first Ising model Hamiltonian and the second Ising model Hamiltonian by simulated annealing using a classical system.

11. A system comprising
at least one processor of a classical system;
at least one annealing system configured to generate a first result and a second result;
an application that, when executing on the at least one processor, performs:
encoding a first objective function and trace values as a first Ising model Hamiltonian;
annealing the first Ising model Hamiltonian using the at least one annealing system to obtain the first result;
decoding the first result to output reflectivity values;
encoding a second objective function and the reflectivity values as a second Ising model Hamiltonian;
annealing the second Ising model Hamiltonian using the at least one annealing system to obtain the second result; and
decoding the second result to output acoustic impedance values.

12. The system of claim 11, wherein the application further performs:
presenting one or more of the trace values, the reflectivity values, and the acoustic impedance values in one or more graphs, wherein the reflectivity values are automatically generated in response to receiving the trace values, and the acoustic impedance values are automatically generated in response to receiving the reflectivity values; and
presenting one of a trace value, a reflectivity value, and an acoustic impedance value from one of the trace values, the reflectivity values, and the acoustic impedance values in response to a user input, wherein the user input comprises hovering a mouse over a graph of the one or more graphs.

13. The system of claim 11, wherein the application further performs:
encoding the first objective function, wherein the first objective function combines the trace values with the reflectivity values and the reflectivity values are convolved with wavelet values.

14. The system of claim 11, wherein the application further performs:
annealing the first Ising model Hamiltonian using the at least one annealing system to minimize an output of the first objective function, wherein the first result comprises the reflectivity values represented with quantum bits during the annealing.

15. The system of claim 11, wherein the application further performs:
decoding the first result to output the reflectivity values, wherein the reflectivity values are represented with classical bits after the decoding.

16. The system of claim 11, wherein the application further performs:
generating low frequency acoustic impedance values, used in the second objective function, from well log data.
encoding the second objective function, wherein the second objective function combines the acoustic impedance values with the reflectivity values and combines the acoustic impedance values with low frequency acoustic impedance values and a regularization parameter.

17. The system of claim 11, wherein the application further performs:
annealing the second Ising model Hamiltonian using the at least one annealing system to minimize an output of the second objective function, wherein the second result comprises the acoustic impedance values represented with quantum bits during the annealing.

18. The system of claim 11, wherein the application further performs:
decoding the second result to output the acoustic impedance values, wherein the acoustic impedance values are represented with classical bits after the decoding.

19. The system of claim 11, wherein the application further performs:
annealing one or more of the first Ising model Hamiltonian and the second Ising model Hamiltonian by quantum annealing using a quantum system.

20. A non-transitory computer readable medium comprising instructions executable by at least one processor to perform:
encoding a first objective function and trace values as a first Ising model Hamiltonian;
annealing the first Ising model Hamiltonian to obtain a first result;
decoding the first result to output reflectivity values;
encoding a second objective function and the reflectivity values as a second Ising model Hamiltonian;
annealing the second Ising model Hamiltonian to obtain a second result; and
decoding the second result to output acoustic impedance values.
